(19) United States
(12) Patent Application Publication
(10) Pub. No.: US 2026/0222259 A1
(43) Pub. Date: Jul. 30, 2026

(54) CHANNEL ESTIMATION FOR PRECODED TRANSMISSIONS

(71) Applicant: Telefonaktiebolaget LM Ericsson (publ), Stockholm (SE)

(72) Inventors: Claes Tidestav, Bålsta (SE); Mattias Frenne, Uppsala (SE); Erik Erikasson, Linköping (SE)

(21) Appl. No.: 19/145,439

(22) PCT Filed: Jan. 10, 2024
(86) PCT No.: PCT/IB2024/050258

§ 371 Date: Jul. 2, 2025

Related U.S. Application Data
(60) Provisional application No. 63/438,213, filed on Jan. 10, 2023.

(51) Int. Cl. H04L 27/26; H04L 5/00; H04L 25/02

(52) U.S. Cl. CPC H04L 27/261; H04L 5/0044; H04L 25/0202

(57) ABSTRACT

Various embodiments described herein provide for a method performed by a User Equipment (UE) for performing channel estimation for precoded transmissions received from a network node. In an embodiment, the UE can receive an indication from the network node that indicates whether a first precoder for a first demodulation reference signal (DM-RS) matches a second precoder for a second DM-RS received subsequent to the first transmission. If the precoders match, the UE can determine a frequency offset and a Doppler spread of the first transmission and the second transmission based on a first channel estimate of the first DM-RS and a second channel estimate of the second DM-RS. If the precoders do not match, the UE can determine the frequency offset and the Doppler spread of the first transmission and the second transmission based on a previous frequency offset and a previous Doppler spread.

### RELATED APPLICATIONS

This application claims the benefit of provisional patent application Ser. No. 63/438,213, filed Jan. 10, 2023.

### TECHNICAL FIELD

The present disclosure relates to methods for facilitating channel estimation for precoded transmissions from a network node to a User Equipment device (UE) and a UE and a network node that perform the methods.

### BACKGROUND

### New Radio (NR) Frame Structure and Resource Grid

NR (New Radio) uses CP-OFDM (Cyclic Prefix Orthogonal Frequency Division Multiplexing) in both downlink (i.e., from a network node, gNB, or base station, to a user equipment (UE)) and uplink (i.e., from UE to gNB). In the time domain, NR downlink and uplink are organized into equally-sized subframes of 1 ms each. A subframe is further divided into multiple slots of equal duration. The slot length depends on subcarrier spacing. For subcarrier spacing of Δf=15 kHz, there is only one slot per subframe and each slot consists of 14 OFDM symbols.

Data scheduling in NR is typically in slot basis (an example is shown in FIG. 1 with a 14-symbol slot 102) where the first two symbols 104 and 106 contain Physical Downlink Control Channel (PDCCH) and the rest contains physical shared data channel, either Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15×2^{μ}) kHz where μ∈0,1,2,3,4,5,6. Δf=15 kHz is the basic subcarrier spacing. The slot durations at different subcarrier spacings are given by

$$\frac{1}{{2}^{μ}} ms .$$

In the frequency domain, a system bandwidth is divided into resource blocks (RBs) (e.g., 206), each corresponding to 12 contiguous subcarriers. The RBs are numbered starting with 0 from one end of the system bandwidth. The basic NR physical time-frequency resource grid 202 is illustrated in FIG. 2, where only one RB within a 14-symbol slot is shown. One Orthogonal Frequency Division Multiplexing (OFDM) subcarrier during one OFDM symbol interval forms one resource element (RE) 204.

Downlink (DL) PDSCH transmissions can be either dynamically scheduled, i.e., in each slot the gNB transmits downlink control information (DCI) over PDCCH about which UE data is to be transmitted to and which RBs in the current downlink slot the data is transmitted on, or semi-persistently scheduled (SPS) in which periodic PDSCH transmissions are activated or deactivated by a DCI. Different DCI formats are defined in NR for DL PDSCH scheduling including DCI format 1_0, DCI format 1_1, and DCI format 1_2.

### Demodulation Reference Signals (DM-RS)

Demodulation reference signals (DM-RS) are used for coherent demodulation of physical layer data channels, i.e., PDSCH and PUSCH, as well as of PDCCH. The DM-RS is confined to resource blocks carrying the associated physical layer channel and is mapped on allocated resource elements of the time-frequency resource grid such that the receiver can efficiently handle time/frequency-selective fading radio channels.

The mapping of DM-RS to resource elements is configurable in both frequency and time domain. There are two mapping types in the frequency domain, i.e., type 1 and type 2. In addition, there are two mapping types in the time domain, i.e., mapping type A and type B, which defining the symbol position of the first OFDM symbol containing DM-RS within a transmission interval.

The DM-RS mapping in time domain can further be single-symbol based or double-symbol based, where the latter means that DM-RS is mapped in pairs of two adjacent OFDM symbols. For single symbol based DM-RS, a UE can be configured with one, two, three, or four single-symbol DM-RS in a slot. For double-symbol based DM-RS, a UE can be configured with one or two such double-symbol DM-RS in a slot. In scenarios with low Doppler, it may be sufficient to configure front-loaded DM-RS only, i.e., one single-symbol DM-RS or one double-symbol DM-RS, whereas in scenarios with high Doppler additional DM-RS will be required in a slot.

FIGS. 3A-3D show examples of type 1 and type 2 front-loaded DM-RS with single-symbol and double-symbol DM-RS and time domain mapping type A with first DM-RS in the third OFDM symbol of a transmission interval of 14 symbols. FIG. 3A shows an example of type 1 single symbol DM-RS. FIG. 3B shows an example of type 1 double symbol DM-RS. FIG. 3C shows an example of type 2 single symbol DM-RS. FIG. 3D shows an example of type 2 double symbol DM-RS. It can be observed from these figures that type 1 and type 2 differs with respect to both the mapping structure and the number of supported DM-RS Code Division Multiplexing (CDM) groups where type 1 supports 2 CDM groups and Type 2 support 3 CDM groups.

### Tracking Reference Signal (TRS)

The Tracking Reference Signal (TRS) was introduced in NR for UE time and frequency synchronization. The TRS can also be used for Doppler spread estimation and delay spread estimation. Accurate delay and frequency synchronization is used by the UE to position the FFT window in time and frequency to minimize frequency offset induced phase rotations of received time samples (strongly impacting channel estimation extrapolation and also creating inter-carrier interference) and inter-symbol interference while Doppler spread, and delay spread are used, together with an Signal to Noise Ratio (SNR) estimate, to optimize time and frequency filtering in the channel estimator, respectively.

### Multi-Antenna Precoding

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

A core component in NR is the support of MIMO antenna deployments and MIMO related techniques including beamforming at higher carrier frequencies. Currently Long Term Evolution (LTE) and NR support an 8-layer spatial multiplexing mode to a single UE. The spatial multiplexing mode is aimed for high data rates in favorable channel conditions. An illustration of the spatial multiplexing operation is provided in FIG. 4.

As seen, the information carrying symbol vector s is multiplied by an N_{T}×r precoder matrix W 402, which serves to distribute the transmit energy in a subspace of the N_{T} (corresponding to Nr antenna ports 404-1 to 404-N) dimensional vector space. The precoder matrix is typically selected from a codebook of possible precoder matrices, and typically indicated by means of a precoder matrix indicator (PMI), which specifies a unique precoder matrix in the codebook for a given number of symbol streams. The r symbols in s each correspond to a layer (e.g., 406-1 to 406-N) and r is referred to as the transmission rank. In this way, spatial multiplexing is achieved since multiple symbols can be transmitted simultaneously over the same time/frequency resource element (TFRE). The number of symbols r is typically adapted to suit the current channel properties.

NR can use OFDM in the downlink and hence the received N_{R}×1 vector yₙ for a certain TFRE on subcarrier n (or alternatively data TFRE number n) is thus modeled by:

$${y}_{n} = {H}_{n} W {s}_{n} + {e}_{n}$$

where eₙ is a noise/interference vector obtained as realizations of a random process. The precoder, W 402, can be a wideband precoder, which is constant over frequency, or frequency selective.

The precoder matrix is often chosen to match the characteristics of the N_{R}×N_{T} MIMO channel matrix Hₙ, resulting in so-called channel dependent precoding. This is also commonly referred to as closed-loop precoding and essentially strives for focusing the transmitted energy into a subspace which is strong in the sense of conveying much of the transmitted energy to the UE. In addition, the precoder matrix may also be selected to strive for orthogonalizing the channel, meaning that after proper linear equalization at the UE, the inter-layer interference is reduced.

The transmission rank, and thus the number of spatially multiplexed layers, is reflected in the number of columns of the precoder. For efficient performance, it is important that a transmission rank that matches the channel properties is selected.

### DL Channel Estimation

The DM-RS is intended to be used for channel estimation for demodulation, and the Tracking Reference Signal (TRS) is intended to be used for frequency synchronization, and together with DM-RS for time synchronization. In addition, channel properties such as the SNR, the Doppler spread, fine time delay, and the delay spread of the channel are all needed to select proper filtering in the channel estimator. In LTE these channel properties were typically estimated using the cell-specific reference signal (CRS). In NR, the TRS is used for this purpose.

Schematic views of UE channel estimation can be found in FIG. 5. The raw TRS estimates 502 are used to determine TRS delay estimates 510 for fine frequency and adjustments of the fast fourier transform (FFT) window 514 (assuming that synchronization signal block (SSB) was used to obtain rough frequency and time synchronization). Doppler spread of the channel is also estimated using the TRS. Delay spread, and fine delay estimation is obtained using DM-RS in the channel analyzer.

Frequency offset estimation 508 and compensation is used to adjust the oscillator in the UE at 512 to minimize the frequency difference between the received signal and the transmitted signal and to minimize frequency offset induced phase rotations of received time samples.

Doppler spread estimation 506 is used to tune the time-domain filter of the channel estimator 516 using the SNR, delay, and delay spread 504. Fine timing and delay spread estimation is used to set the frequency-domain filtering of the combining weight calculation 518 in the channel estimator.

### SUMMARY

Various embodiments described herein provide for methods for facilitating channel estimation for precoded transmissions from a network node to a User Equipment device (UE) and a UE and a network node that perform the methods. In an embodiment, the UE can receive an indication from the network node that indicates whether a first precoder for a first demodulation reference signal associated with a first transmission matches or does not match a second precoder for a second demodulation reference signal associated with a second transmission received subsequent to the first transmission. If the indicator indicates that the first precoder matches (e.g., is the same as) the second precoder, the UE can determine a frequency offset and a Doppler spread of the first transmission and the second transmission based on a first channel estimate of the first demodulation reference signal and a second channel estimate of the second demodulation reference signal. If the indicator indicates that the first precoder and the second precoder do not match, the UE can determine the frequency offset and the Doppler spread of the first transmission and the second transmission based on a previous frequency offset and a previous Doppler spread.

In an embodiment, a method performed by a user equipment is provided to perform channel estimation for transmissions from a network node. The method includes receiving an indication from the network node that indicates whether a first demodulation reference signal associated with a first transmission matches or does not match a second demodulation reference signal associated with a second transmission received subsequent to the first transmission. The method also includes optionally, in response to the first demodulation reference signal matching the second demodulation reference signal, determining a frequency offset and a Doppler spread of the first transmission and the second transmission based on a first channel estimate of the first demodulation reference signal and a second channel estimate of the second demodulation reference signal. The method may also include, optionally, in response to the first demodulation reference signal not matching the second demodulation reference signal, determining the frequency offset and the Doppler spread of the first transmission and the second transmission based on a previous frequency offset and a previous Doppler spread.

In an embodiment, in response to the first demodulation reference signal matching the second demodulation reference signal, a first precoder associated with the first demodulation reference signal of the first transmission matches a second precoder associated with the second demodulation reference signal.

In an embodiment, downlink control information associated with the second transmission comprises the indication.

In an embodiment, the downlink control information comprises a bit, wherein a first value of the bit indicates the first demodulation reference signal matches the second demodulation reference signal, and a second value of the bit indicates that the first demodulation reference signal does not match the second demodulation reference signal.

In an embodiment, the indication applies to all demodulation reference signal ports of the second demodulation reference signal.

In an embodiment, the indication applies to a subset of demodulation reference signal ports of the second demodulation reference signal.

In an embodiment, the first transmission is a Physical Downlink Control Channel, PDCCH, transmission and the second transmission is a Physical Downlink Shared Channel, PDSCH, transmission scheduled by the PDCCH transmission.

In an embodiment, the first transmission and the second transmission are respective Physical Downlink Shared Channel, PDSCH, transmissions.

In an embodiment, the first transmission and the second transmission are respective Physical Downlink Control Channel, PDCCH, transmissions.

In an embodiment, each Physical Downlink Shared Channel, PDSCH, layer of the second transmission comprises a bit that indicates whether a respective precoder for each PDSCH layer matches a preceding respective precoder for each PDSCH layer of the first transmission.

In an embodiment, the indication is signaled via Radio Resource Control, RRC, signaling that indicates whether precoders of a set of Physical Downlink Shared Channel, PDSCH, transmissions match.

In an embodiment, the set of PDSCH transmissions are associated with a Radio Network Temporary Identifier, RNTI, type or set of RNTI types.

In an embodiment, the indication indicates that future Physical Downlink Shared Channel, PDSCH, transmissions will use a demodulation reference signal that matches the first demodulation reference signal.

In an embodiment, the indication indicates that future Physical Downlink Shared Channel, PDSCH, transmissions will use respective precoders that match a first precoder of the first demodulation reference signal.

In an embodiment, a user equipment is provided for performing channel estimation for transmissions from a network node and the user equipment includes processing circuitry configured to perform the above methods.

In an embodiment, a method performed by a network node is provided for facilitating channel estimations for transmissions at a user equipment. The method includes providing to the user equipment an indication that indicates whether a first demodulation reference signal associated with a first transmission to the user equipment matches or does not match a second demodulation reference signal associated with a second transmission to the user equipment, wherein the second transmission is provided subsequent to the first transmission.

In an embodiment, in response to the first demodulation reference signal matching the second demodulation reference signal, a first precoder associated with the first demodulation reference signal the first transmission matches a second precoder associated with the second demodulation reference signal.

In an embodiment, the indication is provided in downlink control information associated with the second transmission.

In an embodiment, a network node is provided for facilitating channel estimations for transmissions at a user equipment, and the network node include processing circuitry configured to provide to the user equipment an indication that indicates whether a first demodulation reference signal associated with a first transmission to the user equipment matches or does not match a second demodulation reference signal associated with a second transmission to the user equipment, wherein the second transmission is provided subsequent to the first transmission.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of data scheduling in a slot basis according to one or more embodiments of the present disclosure;

FIG. 2 illustrates an example of a physical time-frequency resource grid according to one or more embodiments of the present disclosure;

FIGS. 3A-3D show examples of type 1 and type 2 front-loaded demodulation reference signals (DM-RS) with single-symbol and double-symbol DM-RS according to one or more embodiments of the present disclosure;

FIG. 4 illustrates spatial multiplexing operation according to one or more embodiments of the present disclosure;

FIG. 5 illustrates views of User Equipment (UE) channel estimation according to one or more embodiments of the present disclosure;

FIG. 6 illustrates a message sequence chart for performing channel estimation by a UE 602 for precoded transmissions received from a network node according to one or more embodiments of the present disclosure;

FIG. 7 shows an example of a communication system 700 in accordance with some embodiments;

FIG. 8 shows a UE in accordance with some embodiments;

FIG. 9 shows a network node in accordance with some embodiments;

FIG. 10 is a block diagram of a host according to some embodiments; and

FIG. 11 is a block diagram illustrating a virtualization environment according to some embodiments.

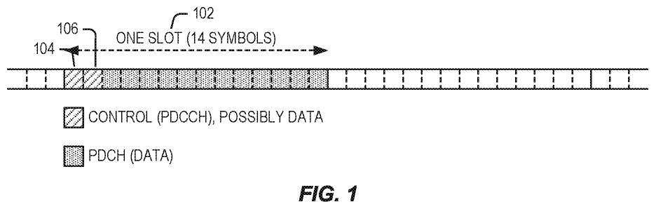

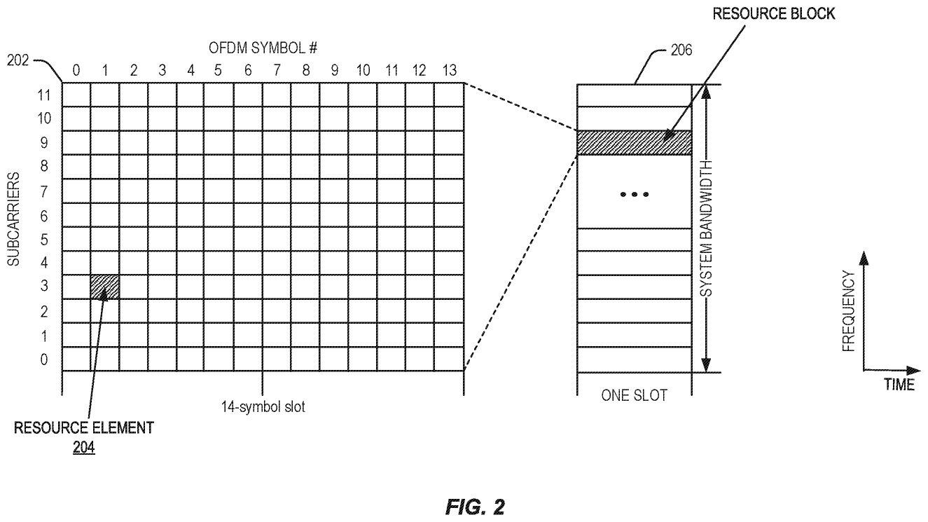

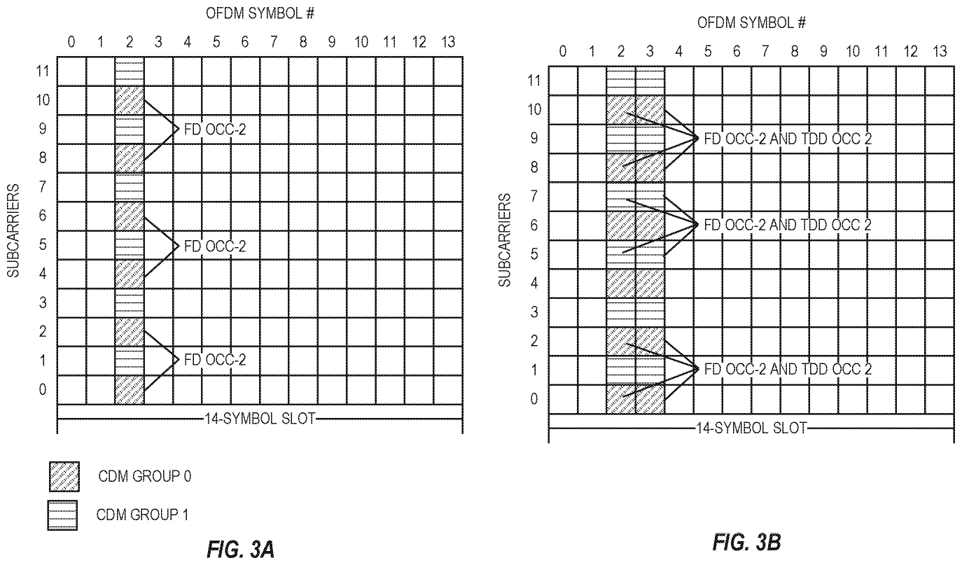

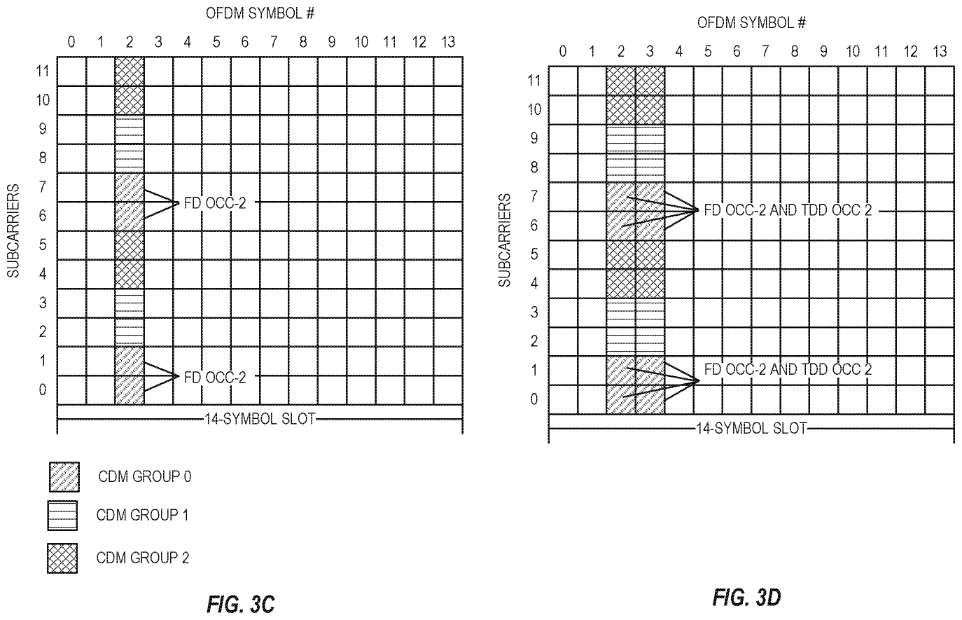

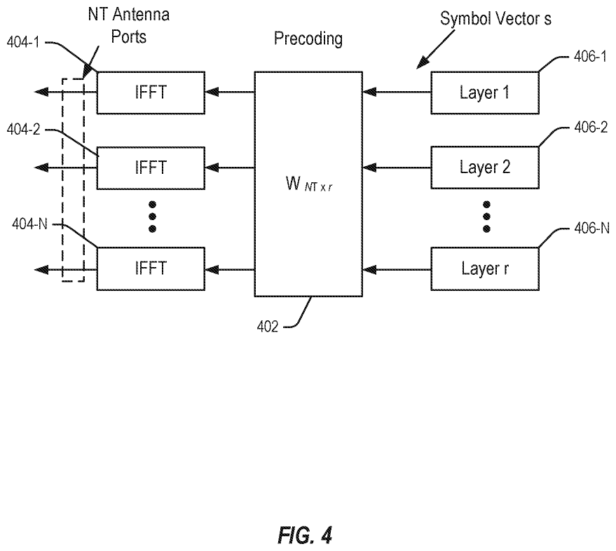

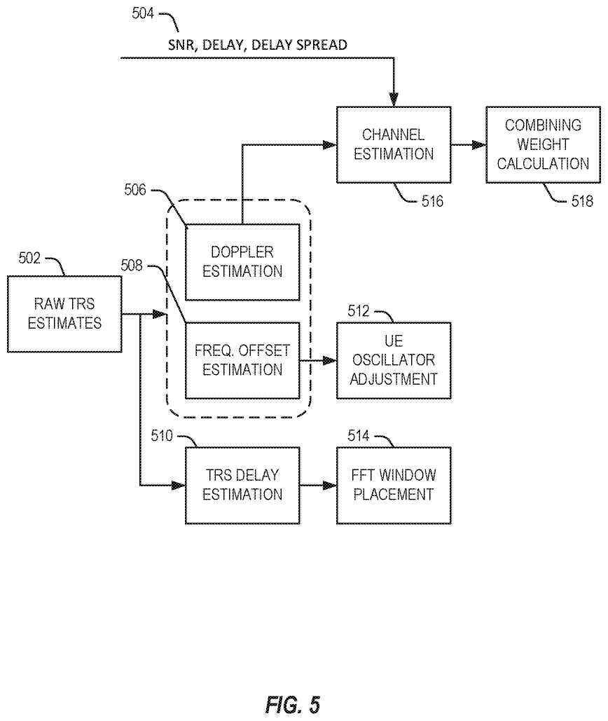

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). When New Radio (NR) was first specified, it was discussed whether the Tracking Reference Signal (TRS) was really needed, or if the User Equipment (UE) could estimate the channel using only the Demodulation Reference Signal (DM-RS). The idea was then that the UE would use the DM-RS for fine frequency adjustment, and to estimate the Doppler spread of the channel. However, to estimate the frequency offset and the Doppler spread (or any other parameter characterizing the channel, here denoted the parameters), the UE would need to estimate the same channel at several time instances, to determine how much the channel has changed over time.

A scheduled Physical Downlink Shared Channel (PDSCH) typically has multiple DM-RS instances, separated in time. However, the time span of these may be too short for accuracy estimation of the mentioned parameters, which is a problem. Another option could then be that the UE utilizes subsequently received PDSCH to perform a better estimate of the parameters. Unfortunately, the channel estimated by DM-RS includes both the actual propagation channel and the precoding, as described above. The UE cannot determine if the channel estimated from DM-RS in two different time instances has changed due to a changed propagation channel, or a changed precoder. Hence, with state-of-the-art solutions, the UE cannot use DM-RS from different PDSCHs jointly to estimate the parameters.

Certain aspects of the disclosure and their embodiments may provide solutions to these or other challenges. Certain embodiments may include an indication to the UE that the precoder has not changed for one received PDSCH to another received PDSCH. If the UE is indicated that the precoder has not changed, any change in the DM-RS channel estimate is caused by changes in the propagation channel, and the UE can use these DM-RS channel estimates to estimate the frequency offset and the Doppler spread.

Certain embodiments may include a method to indicate to the transmit precoder on the network side has not changed, which enables the UE to perform frequency adjustment and Doppler spread information based on DM-RS.

In an embodiment, if the indication is enabled, then the can UE assume that a DM-RS ports of the previously received PDSCH is the same port as the corresponding DM-RS port in the current received PDSCH. Alternatively, the UE can assume a DM-RS ports of the previously received Physical Downlink Control Channel (PDCCH) is the same port as the corresponding DM-RS port in the current received PDCCH.

Certain embodiments may provide one or more of the following technical advantage(s). Certain embodiments may enable the frequency adjustment and Doppler spread estimation without TRS. Since no TRS is transmitted, the energy consumption of the base station is reduced, Reference Signal (RS) overhead is reduced and interference to other cells may in some cases be reduced.

Various embodiments described herein provide for a method performed by a UE for performing channel estimation for precoded transmissions received from a network node. In an embodiment, the UE can receive an indication from the network node that indicates whether a first precoder for a first demodulation reference signal associated with a first transmission matches or does not match a second precoder for a second demodulation reference signal associated with a second transmission received subsequent to the first transmission. If the indicator indicates that the first precoder matches (e.g., is the same as) the second precoder, the UE can determine a frequency offset and a Doppler spread of the first transmission and the second transmission based on a first channel estimate of the first demodulation reference signal and a second channel estimate of the second demodulation reference signal. If the indicator indicates that the first precoder and the second precoder do not match, the UE can determine the frequency offset and the Doppler spread of the first transmission and the second transmission based on a previous frequency offset and a previous Doppler spread.

In a main embodiment, an indication is introduced, which informs the UE that the precoder of one reference signal is the same as the precoder of a second reference signal. In a related embodiment the first reference and second reference signal are transmitted at different time instances. In a preferred embodiment, both first and second reference signal are the DM-RS of the PDSCH, transmitted at different time instances. In yet another embodiment, both first and second reference signal are the DM-RS of the PDCCH, transmitted at different time instances.

In a preferred embodiment, an indicator is included in the Downlink Control Information (DCI), which informs the UE that the multi-antenna transmit precoder of the PDSCH has not changed. In specification, this may be described as the if the indication is enabled, then can the UE assume that a DM-RS ports of the previously received PDSCH is the same port as the corresponding DM-RS port in the current received PDSCH. If the indication is not enabled, then the UE shall not assume that a DM-RS ports of the previously received PDSCH is the same port as the corresponding DM-RS port in the current received PDSCH.

Based on this information, the UE knows if the indicator is enabled that any changed observed in the channel estimated from the DM-RS is a result of that the propagation channel has changed. In other words, the UE may assume that the antenna ports of the previously received PDSCH are the same antenna port as in the currently scheduled PDSCH. The UE can then estimate the frequency shift and Doppler spread (i.e., the parameters) from the two sets of estimated channels, (one channel set per PDSCH, note that within one PDSCH, there may be multiple DM-RS occasions hence each PDSCH DM-RS may in this case provide a set of channel estimates).

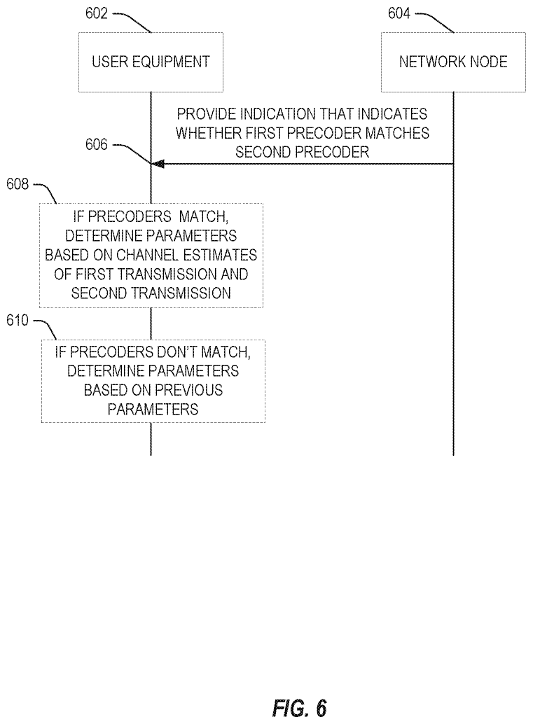

If the indicator indicates that the precoder has changed, the UE cannot use the corresponding channel estimate to estimate the frequency shift, or Doppler spread. Instead, the UE may keep using the old estimate. The procedure is illustrated in FIG. 6.

FIG. 6 depicts a message sequence chart for performing channel estimation by a UE 602 for precoded transmissions received from a network node 604.

At 606, the network node 604 can provide to the UE 602 an indication that indicates whether a first precoder for a first demodulation reference signal associated with a first transmission matches or does not match a second precoder for a second demodulation reference signal associated with a second transmission received subsequent to the first transmission.

At 608, the UE 602 can optionally, in response to the first precoder matching the second precoder, determine a frequency offset and a Doppler spread of the first transmission and the second transmission based on a first channel estimate of the first demodulation reference signal and a second channel estimate of the second demodulation reference signal.

At 610, the UE 602 can optionally, in response to the first precoder not matching the second precoder, determine the frequency offset and the Doppler spread of the first transmission and the second transmission based on a previous frequency offset and a previous Doppler spread.

In an embodiment, the first transmission is a PDCHH transmission, and the second transmission is a PDSCH transmission scheduled by the PDCCH transmission. In such an embodiment, the indication may only apply to a subset of demodulation reference signal ports.

In other embodiments, the first and second transmissions may be PDCCH transmissions, or alternatively, the first and second transmissions may be PDSCH transmissions.

In another embodiment, the indication only applies to a subset of the DM-RS ports. For example, the UE 602 may assume that the precoder for the DM-RS port with the lowest (or highest or a pre-defined) port number has not changed while precoding vectors for other layers may have changed (the UE 602 cannot make any assumption of these ports). In other words, the UE 602 may assume in this embodiment that the antenna port X of the previously received PDSCH is the same antenna port as in the currently scheduled PDSCH port X.

In one embodiment, the indication is one bit: 0 means “the precoder has not changed” and 1 means “the precoder has changed” (or equivalently, that 0 means “the corresponding antenna port of the two PDSCH are the same” and 1 means “the UE shall not assume that the corresponding antenna ports of the PDSCH are the same”)

The indication can alternatively be provided as one bit per PDSCH layer. In this case, each bit provides information if the precoder for the corresponding PDSCH layer has changed. Thus, if the n-th bit is 0, the precoder for the n-th layer has not changed, and if the n-th bit is 1, the precoder for the n-th layer has changed.

In another embodiment, toggling of one or multiple bits in DCI carries the information: the same bit-combination in consecutive DCIs means that the precoder has not changed and a different bit combination means the precoder has changed. Also in this case, the indication may be conveyed per UE, or per layer.

The indicator may only be valid for some Radio Network Temporary Identifier (RNTI)'s and/or search spaces, e.g., the indicator shall be used when scheduled by Cell RNTI (C-RNTI) in UE specific search spaces, (since these are dedicated channels which may use dedicated precoding), while the UE can ignore the indicator if scheduled in a common search space and using e.g., System Information RNTI (SI-RNTI), RA-RNTI, (since these are broadcasted channels and use broadcast precoding). Hence, If the UE receives three PDSCHs in sequence, based on C-RNTI, RA-RNTI and C-RNTI respectively, then the UE shall assume the two PDSCH corresponding to the same C-RNTI was transmitted using the same precoder.

The indicator may be Radio Resource Control (RRC) configured per control resource set (CORESET), hence if the UE 602 receives two PDSCH scheduled from the same CORESET with the indicator enabled, then the UE 602 may assume that the DM-RS port X of the two PDSCHs is the same port (i.e., the same transmit precoder is used from the network side). In a further embodiment, a higher layer configuration such as RRC can be used to indicate whether the UE 602 can assume the same transmit precoder across PDSCH receptions for a given RNTI type or set of RNTI types. For example, the network node 604 can indicate to the UE 602 that PDSCH scheduled by a PDCCH where cyclic redundancy check (CRC) bits are scrambled with SI-RNTI is using the same transmit precoder to enable estimation of said parameters.

In case of carrier aggregation, the PDSCHs on different component carriers may be scheduled by separate PDCCHs. In this case, the indication may be provided per component carrier.

In some embodiments may the indication instead be forward in time, indicating that any potential scheduling of PDSCH for the next pre-configured or signaled time-period will use the same precoder as the currently scheduled PDSCH, if such subsequent PDSCH are present.

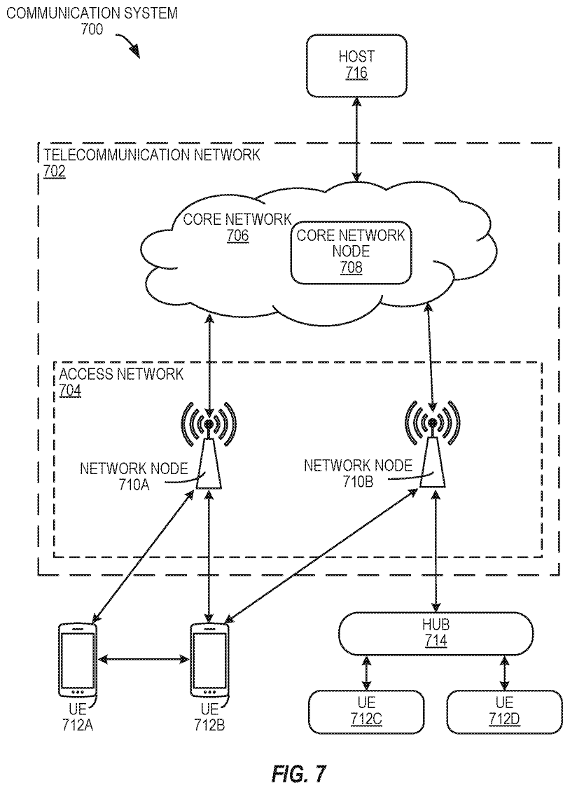

FIG. 7 shows an example of a communication system 700 in accordance with some embodiments.

In the example, the communication system 700 includes a telecommunication network 702 that includes an access network 704, such as a Radio Access Network (RAN), and a core network 706, which includes one or more core network nodes 708. The access network 704 includes one or more access network nodes, such as network nodes 710A and 710B (one or more of which may be generally referred to as network nodes 710), or any other similar Third Generation Partnership Project (3GPP) access node or non-3GPP Access Point (AP). The network nodes 710 facilitate direct or indirect connection of UE, such as by connecting UEs 712A, 712B, 712C, and 712D (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system 700 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 702 is a cellular network that implements 3GPP standardized features. Accordingly, the telecommunication network 702 may support network slicing to provide different logical networks to different devices that are connected to the telecommunication network 702. For example, the telecommunication network 702 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 714 communicates with the access network 704 to facilitate indirect communication between one or more UEs (e.g., UE 712C and/or 712D) and network nodes (e.g., network node 710B). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a Virtual Reality (VR) headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710B. The hub 714 may also allow for a different communication scheme and/or schedule between the hub 714 and UEs (e.g., UE 712C and/or 712D), and between the hub 714 and the core network 706. In other examples, the hub 714 is connected to the core network 706 and/or one or more UEs via a wired connection. Moreover, the hub 714 may be configured to connect to a Machine-to-Machine (M2M) service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710B. In other embodiments, the hub 714 may be a non-dedicated hub—that is, a device which is capable of operating to route communications between the UEs and the network node 710B, but which is additionally capable of operating as a communication start and/or end point for certain data channels.

FIG. 8 shows a UE 800 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 802 may include multiple Central Processing Units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging the power source 808. Power circuitry may perform any formatting, converting, or other modification to the power from the power source 808 to make the power suitable for the respective components of the UE 800 to which power is supplied.

The memory 810 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 810 may allow the UE 800 to access instructions, application programs, and the like stored on transitory or non-transitory memory media, to off-load data, or to upload data. An article of manufacture, such as one utilizing a communication system, may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., the antenna 822) and may share circuit components, software, or firmware, or alternatively be implemented separately.

In the illustrated embodiment, communication functions of the communication interface 812 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 812, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

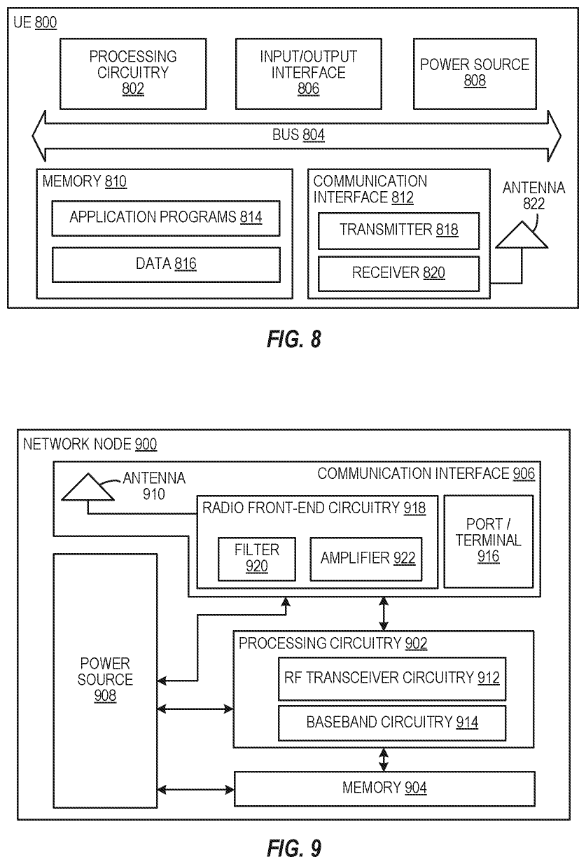

FIG. 9 shows a network node 900 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes processing circuitry 902, memory 904, a communication interface 906, and a power source 908. The network node 900 may be composed of multiple physically separate components (e.g., a Node B component and an RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 900 may be configured to support multiple RATs. In such embodiments, some components may be duplicated (e.g., separate memory 904 for different RATs) and some components may be reused (e.g., an antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 900.

The processing circuitry 902 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 900 components, such as the memory 904, to provide network node 900 functionality.

In some embodiments, the processing circuitry 902 includes a System on a Chip (SOC). In some embodiments, the processing circuitry 902 includes one or more of Radio Frequency (RF) transceiver circuitry 912 and baseband processing circuitry 914. In some embodiments, the RF transceiver circuitry 912 and the baseband processing circuitry 914 may be on separate chips (or sets of chips), boards, or units, such as radio units and digital units. In alternative embodiments, part or all of the RF transceiver circuitry 912 and the baseband processing circuitry 914 may be on the same chip or set of chips, boards, or units.

The memory 904 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and the memory 904 are integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. The radio front-end circuitry 918 comprises filters 920 and amplifiers 922. The radio front-end circuitry 918 may be connected to the antenna 910 and the processing circuitry 902. The radio front-end circuitry 918 may be configured to condition signals communicated between the antenna 910 and the processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of the filters 920 and/or the amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface 906 may comprise different components and/or different combinations of components.

In certain alternative embodiments, the network node 900 does not include separate radio front-end circuitry 918; instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes the one or more ports or terminals 916, the radio front-end circuitry 918, and the RF transceiver circuitry 912 as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, the communication interface 906, and/or the processing circuitry 902 may be configured to perform any receiving operations and/or certain obtaining operations described herein as being performed by the network node 900. Any information, data, and/or signals may be received from a UE, another network node, and/or any other network equipment. Similarly, the antenna 910, the communication interface 906, and/or the processing circuitry 902 may be configured to perform any transmitting operations described herein as being performed by the network node 900. Any information, data, and/or signals may be transmitted to a UE, another network node, and/or any other network equipment.

The power source 908 provides power to the various components of the network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid or an electricity outlet) via input circuitry or an interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

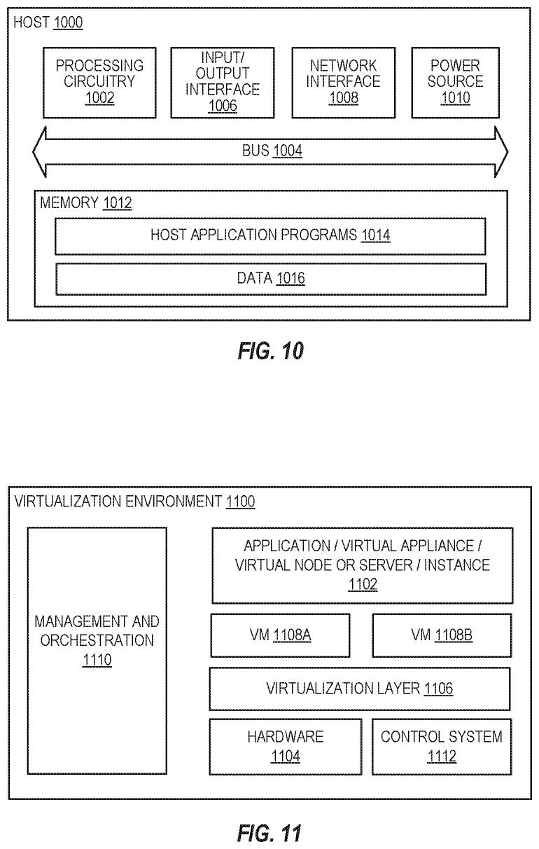

FIG. 10 is a block diagram of a host 1000, which may be an embodiment of the host 716 of FIG. 7, in accordance with various aspects described herein. As used herein, the host 1000 may be or comprise various combinations of hardware and/or software including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and memory 1012. Other components may be included in other embodiments. Features of these components may be substantially similar to those described with respect to the devices of previous figures, such as FIGS. 8 and 9, such that the descriptions thereof are generally applicable to the corresponding components of the host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for Over-The-Top (OTT) services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or VM Monitors (VMMs)), provide VMs 1108A and 1108B (one or more of which may be generally referred to as VMs 1108), and/or perform any of the functions, features, and/or benefits described in relation with some embodiments described herein. The virtualization layer 1106 may present a virtual operating platform that appears like networking hardware to the VMs 1108.

The VMs 1108 comprise virtual processing, virtual memory, virtual networking, or interface and virtual storage, and may be run by a corresponding virtualization layer 1106. Different embodiments of the instance of a virtual appliance 1102 may be implemented on one or more of the VMs 1108, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1108 may be a software implementation of a physical machine that runs programs as if they were executing on a physical, non-virtualized machine. Each of the VMs 1108, and that part of the hardware 1104 that executes that VM, be it hardware dedicated to that VM and/or hardware shared by that VM with others of the VMs 1108, forms separate virtual network elements. Still in the context of NFV, a virtual network function is responsible for handling specific network functions that run in one or more VMs 1108 on top of the hardware 1104 and corresponds to the application 1102.

The hardware 1104 may be implemented in a standalone network node with generic or specific components. The hardware 1104 may implement some functions via virtualization. Alternatively, the hardware 1104 may be part of a larger cluster of hardware (e.g., such as in a data center or CPE) where many hardware nodes work together and are managed via management and orchestration 1110, which, among others, oversees lifecycle management of the applications 1102. In some embodiments, the hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1112 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a user equipment (602) for performing channel estimation for transmissions from a network node (604), the method comprising: receiving (606) an indication from the network node (604) that indicates whether a first demodulation reference signal associated with a first transmission matches or does not match a second demodulation reference signal associated with a second transmission received subsequent to the first transmission; optionally, in response to the first demodulation reference signal matching the second demodulation reference signal, determining (608) a frequency offset and a Doppler spread of the first transmission and the second transmission based on a first channel estimate of the first demodulation reference signal and a second channel estimate of the second demodulation reference signal; and/or optionally, in response to the first demodulation reference signal not matching the second demodulation reference signal, determining (610) the frequency offset and the Doppler spread of the first transmission and the second transmission based on a previous frequency offset and a previous Doppler spread.

Embodiment 2: The method of embodiment 1, wherein in response to the first demodulation reference signal matching the second demodulation reference signal, a first precoder associated with the first demodulation reference signal the first transmission matches a second precoder associated with the second demodulation reference signal.

Embodiment 3: The method of embodiment 1, wherein in response to the first demodulation reference signal matching the second demodulation reference signal determining that at least one port of each of the first demodulation reference signal and second demodulation reference signal match.

Embodiment 4: The method of embodiment 1, wherein downlink control information associated with the second transmission comprises the indication.

Embodiment 5: The method of embodiment 4, wherein the downlink control information comprises a bit, wherein a first value of the bit indicates the first demodulation reference signal matches the second demodulation reference signal, and a second value of the bit indicates that the first demodulation reference signal does not match the second demodulation reference signal.

Embodiment 6: The method of any of embodiments 1 to 5, wherein the indication applies to all demodulation reference signal ports of the second demodulation reference signal.

Embodiment 7: The method of any of embodiments 1 to 5, wherein the indication applies to a subset of demodulation reference signal ports of the second demodulation reference signal.

Embodiment 8: The method of embodiment 7, wherein the subset of demodulation reference signal ports are predefined.

Embodiment 9: The method of embodiment 7, wherein the first transmission is a Physical Downlink Control Channel, PDCCH, transmission and the second transmission is a Physical Downlink Shared Channel, PDSCH, transmission scheduled by the PDCCH transmission.

Embodiment 10: The method of any of embodiments 1 to 8, wherein the first transmission and the second transmission are respective Physical Downlink Shared Channel, PDSCH, transmissions.

Embodiment 11: The method of any of embodiments 1 to 8, wherein the first transmission and the second transmission are respective Physical Downlink Control Channel, PDCCH, transmissions.

Embodiment 12: The method of embodiment 1, wherein each Physical Downlink Shared Channel, PDSCH, layer of the second transmission comprises a bit that indicates whether a respective precoder for each PDSCH layer matches a preceding respective precoder for each PDSCH layer of the first transmission.

Embodiment 13: The method of embodiment 1, wherein the indication is signaled via Radio Resource Control, RRC, signaling that indicates whether precoders of a set of Physical Downlink Shared Channel, PDSCH, transmissions match.

Embodiment 14: The method of embodiment 13, wherein the set of PDSCH transmissions are associated with a Radio Network Temporary Identifier, RNTI, type or set of RNTI types.

Embodiment 15: The method of embodiment 1, wherein the indication indicates that future Physical Downlink Shared Channel, PDSCH, transmissions will use a same demodulation reference signal as the first demodulation reference signal.

Embodiment 16: The method of embodiment 1, wherein the indication comprises a plurality of bits, wherein a first combination of the plurality of bits indicates the first demodulation reference signal matches the second demodulation reference signal, and a second combination of bits indicates the first demodulation reference signal does not match the second demodulation reference signal.

Embodiment 17: A user equipment (602) for performing channel estimation for transmissions from a network node (604), the user equipment (602) comprising processing circuitry configured to receive (606) an indication from the network node (604) that indicates whether a first demodulation reference signal associated with a first transmission matches or does not match a second demodulation reference signal associated with a second transmission received subsequent to the first transmission. The processing circuitry can also optionally, in response to the first demodulation reference signal matching the second demodulation reference signal, determine (608) a frequency offset and a Doppler spread of the first transmission and the second transmission based on a first channel estimate of the first demodulation reference signal and a second channel estimate of the second demodulation reference signal. The processing circuitry can also optionally, in response to the first demodulation reference signal not matching the second demodulation reference signal, determine (610) the frequency offset and the Doppler spread of the first transmission and the second transmission based on a previous frequency offset and a previous Doppler spread.

Embodiment 18: The user equipment (602) of embodiment 17, wherein the processing circuitry is further configured to perform any of the steps of embodiments 2-16.

### Group B Embodiments

Embodiment 19: A method performed by a network node (604) for facilitating channel estimations for transmissions at a user equipment (602), the method comprising providing (606) to the user equipment (602) an indication that indicates whether a first demodulation reference signal associated with a first transmission to the user equipment (602) matches or does not match a second demodulation reference signal associated with a second transmission to the user equipment (602), wherein the second transmission is provided subsequent to the first transmission.

Embodiment 20: The method of embodiment 19, wherein in response to the first demodulation reference signal matching the second demodulation reference signal, a first precoder associated with the first demodulation reference signal the first transmission matches a second precoder associated with the second demodulation reference signal.

Embodiment 21: The method of embodiment 19, wherein the indication is provided in downlink control information associated with the second transmission.

Embodiment 22: The method of embodiment 21, wherein the downlink control information comprises a bit, wherein a first value of the bit indicates the first demodulation reference signal matches the second demodulation reference signal, and a second value of the bit indicates that first demodulation reference signal does not match the second demodulation reference signal.

Embodiment 23: The method of any of embodiments 19 to 22, wherein the indication applies to all demodulation reference signal ports of the second demodulation reference signal.

Embodiment 24: The method of any of embodiments 19 to 22, wherein the indication applies to a subset of demodulation reference signal ports of the second demodulation reference signal.

Embodiment 25: The method of embodiment 24, wherein the subset of demodulation reference signal ports are predefined.

Embodiment 26: The method of embodiment 24, wherein the first transmission is a Physical Downlink Control Channel, PDCCH, transmission and the second transmission is a Physical Downlink Shared Channel, PDSCH, transmission scheduled by the PDCCH transmission.

Embodiment 27: The method of any of embodiments 19 to 25, wherein the first transmission and the second transmission are respective Physical Downlink Shared Channel, PDSCH, transmissions.

Embodiment 28: The method of any of embodiments 19 to 25, wherein the first transmission and the second transmission are respective Physical Downlink Control Channel, PDCCH, transmissions.

Embodiment 29: The method of embodiment 19, wherein each Physical Downlink Shared Channel, PDSCH, layer of the second transmission comprises a bit that indicates whether a respective precoder for each PDSCH layer matches a preceding respective precoder for each PDSCH layer of the first transmission.

Embodiment 30: The method of embodiment 19, further comprising providing the indication via Radio Resource Control, RRC, signaling that indicates whether precoders of a set of Physical Downlink Shared Channel, PDSCH, transmissions match.

Embodiment 31: The method of embodiment 30, wherein the set of PDSCH transmissions are associated with a Radio Network Temporary Identifier, RNTI, type or set of RNTI types.

Embodiment 32: The method of embodiment 19, wherein the indication indicates that future Physical Downlink Shared Channel, PDSCH, transmissions will use a same demodulation reference signal as the first demodulation reference signal.

Embodiment 33: A network node (604) for facilitating channel estimations for transmissions at a user equipment (602), the network node (604) comprising processing circuitry that is configured to provide (606) to the user equipment (602) an indication that indicates whether a first demodulation reference signal associated with a first transmission to the user equipment (602) matches or does not match a second demodulation reference signal associated with a second transmission to the user equipment (602), wherein the second transmission is provided subsequent to the first transmission.

Embodiment 34: The network node (604) of embodiment 33, wherein the processing circuitry is further configured to perform any of the steps of embodiments 20-32.

Those skilled in the art will recognize improvements and modifications to the embodiments of the present disclosure. All such improvements and modifications are considered within the scope of the concepts disclosed herein.

1.-21. (canceled)

22. A method performed by a user equipment for performing channel estimation for transmissions from a network node, the method comprising:
receiving an indication from the network node that indicates whether a transmission of a first demodulation reference signal associated with a first transmission matches or does not match a transmission of a second demodulation reference signal associated with a second transmission received subsequent to the first transmission.

23. The method of claim 22, further comprising:
in response to the transmission of the first demodulation reference signal matching the transmission of the second demodulation reference signal, determining a frequency offset and/or a Doppler spread based on a first channel estimate for the first demodulation reference signal and a second channel estimate for the second demodulation reference signal.

24. The method of claim 23, further comprising:
in response to the transmission of the first demodulation reference signal not matching the transmission of the second demodulation reference signal, determining the frequency offset and/or the Doppler spread based on a previous frequency offset and/or a previous Doppler spread.

25. The method of claim 22, wherein that the transmission of the first demodulation reference signal matches the transmission of the second demodulation reference signal comprises that a precoder used for transmission of the first demodulation reference signal matches a precoder used for transmission of the second demodulation reference signal.

26. The method of claim 22, wherein that the transmission of the first demodulation reference signal matches the transmission of the second demodulation reference signal comprises that at least one demodulation reference signal port used for transmission of the first demodulation reference signal represents the same antenna port as at least one demodulation reference signal port used for transmission of the second demodulation reference signal.

27. The method of claim 22, wherein downlink control information associated with the second transmission comprises the indication.

28. The method of claim 27, wherein the downlink control information comprises a bit, wherein a first value of the bit indicates that the transmission of the first demodulation reference signal matches the transmission of the second demodulation reference signal, and wherein a second value of the bit indicates that the transmission of the first demodulation reference signal does not match the transmission of the second demodulation reference signal.

29. The method of any claim 22, wherein the first transmission is a Physical Downlink Control Channel (PDCCH) transmission and the second transmission is a Physical Downlink Shared Channel (PDSCH) transmission scheduled by the PDCCH transmission.

30. The method of claim 22, wherein the first transmission and the second transmission are respective Physical Downlink Shared Channel (PDSCH) transmissions.

31. The method of claim 22, wherein the first transmission and the second transmission are respective Physical Downlink Control Channel (PDCCH) transmissions.

32. The method of claim 22, wherein the received indication comprises bits for respective Physical Downlink Shared Channel (PDSCH) layers, wherein the bits indicate whether the transmission of the first demodulation reference signal matches or does not match the transmission of the second demodulation reference signal at the respective PDSCH layers.

33. The method of claim 22, wherein the indication is received via downlink control information, and wherein toggling of one or more bits in the downlink control information compared to preceding downlink control information indicates that that the transmission of the first demodulation reference signal does not match the transmission of the second demodulation reference signal.

34. The method of claim 22, wherein the first transmission is associated with a first type of Radio Network Temporary Identifier (RNTI), and wherein the received indication is specific for the type of RNTI such that it does not apply for a third transmission that occurs between the first transmission and the second transmission when the third transmission is associated with a different type of RNTI.

35. The method of claim 34, wherein the first type of RNTI is cell RNTI (C-RNTI), and wherein the different type of RNTI is system information RNTI (SI-RNTI) or random access RNTI (RA-RNTI).

36. The method of claim 22, wherein the indication indicates that future Physical Downlink Shared Channel (PDSCH) transmissions will use demodulation reference signal transmissions that match the transmission of the first demodulation reference signal.

37. The method of claim 22, wherein the indication indicates that future Physical Downlink Shared Channel (PDSCH) transmissions will use respective precoders that match a precoder used for the transmission of the first demodulation reference signal.

38. A user equipment for performing channel estimation for transmissions from a network node, the user equipment comprising:
processing circuitry configured to:
receive an indication from the network node that indicates whether a transmission of a first demodulation reference signal associated with a first transmission matches or does not match a transmission of a second demodulation reference signal associated with a second transmission received subsequent to the first transmission.

39. The user equipment of claim 38, wherein that the transmission of the first demodulation reference signal matches the transmission of the second demodulation reference signal comprises that a precoder used for transmission of the first demodulation reference signal matches a precoder used for transmission of the second demodulation reference signal.

40. A method performed by a network node for facilitating channel estimations for transmissions at a user equipment, the method comprising:
providing to the user equipment an indication that indicates whether a transmission of a first demodulation reference signal associated with a first transmission to the user equipment matches or does not match a transmission of a second demodulation reference signal associated with a second transmission to the user equipment, wherein the second transmission is provided subsequent to the first transmission.

41. A network node for facilitating channel estimations for transmissions at a user equipment, the network node comprising:
processing circuitry configured to:
provide to the user equipment an indication that indicates whether a transmission of a first demodulation reference signal associated with a first transmission to the user equipment matches or does not match a transmission of a second demodulation reference signal associated with a second transmission to the user equipment, wherein the second transmission is provided subsequent to the first transmission.
